(19) United States
(12) Patent Application Publication
(10) Pub. No.: US 2009/0260938 A1
(43) Pub. Date: Oct. 22, 2009

(54) SHOCK ABSORBER

(76) Inventor: Kenji HIKOSAKA, Yokohama-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/391,641

(22) Filed: Feb. 24, 2009

(30) Foreign Application Priority Data
Feb. 29, 2008 (JP) 50619/2008

(51) Int. Cl. F16F 9/34

(52) U.S. Cl. 188/322.15

(57) ABSTRACT

A shock absorber has a seat disk seated on a valve seat of a piston. A disk valve opens and closes a slot provided in the seat disk to extend in the circumferential direction thereof. In a low piston speed region, an orifice passage generates a damping force of orifice characteristics. In an intermediate piston speed region, the disk valve opens to generate a damping force of valve characteristics. In a high piston speed region, the seat disk opens to prevent an excessive increase in damping force. The disk valve partially opens the slot relative to the circumferential direction to gradually increase the flow path area, thereby preventing a sharp change in damping force in a transitional region from the low to intermediate piston speed region.

### BACKGROUND OF THE INVENTION

The present invention relates to shock absorbers such as hydraulic shock absorbers that utilize a fluid pressure.

In general, cylinder-type hydraulic shock absorbers attached to suspension systems of automobiles or other vehicles are structured as follows. A piston connected with a piston rod is slidably fitted in a cylinder having a hydraulic fluid sealed therein. The piston is provided with a damping force generating mechanism including an orifice and a disk valve. The damping force generating mechanism generates a damping force by controlling, through the orifice and the disk valve, the flow of hydraulic fluid induced by sliding movement of the piston in the cylinder, which is caused by the extension and contraction of the piston rod.

When the piston speed is low (i.e. in a low piston speed region), the orifice generates a damping force of orifice characteristics (in which the damping force is approximately proportional to the square of the piston speed). When the piston speed is high (i.e. in a high piston speed region), the disk valve deflects to open, thereby generating a damping force of valve characteristics (in which the damping force is approximately proportional to the piston speed). The conventional hydraulic shock absorber enables damping force characteristics to be set for each of the low, intermediate and high piston speed regions. For the low piston speed region, damping force characteristics are set on the basis of the orifice area. For the intermediate piston speed region, damping force characteristics are set on the basis of the flexural rigidity of the disk valve when and after it has opened. For the high piston speed region, damping force characteristics are set on the basis of the flexural rigidity of the disk valve after it has opened, or based on the cross-sectional area (flow path area) of a passage provided in the piston.

It is desired for this type of hydraulic shock absorber to provide linear damping force characteristics from the low piston speed region and to allow the damping force characteristics to smoothly shift from the low to intermediate piston speed region without a sharp change in damping force, from the viewpoint of preventing the generation of noise during the operation of the shock absorber and improving the ride quality of the vehicle.

Under these circumstances, Japanese Patent Application Publication No. Hei 3-163234, for example, proposes a hydraulic shock absorber in which a seat surface on which a disk valve seats is formed into a non-circular shape, and the disk valve is opened stepwisely from one side thereof that is larger in pressure-receiving area than the other side, thereby preventing a sharp change in damping force to prevent the generation of noise and to improve the ride quality.

If the seat surface is formed into a non-circular shape as in the above-described Japanese Patent Application Publication No. Hei 3-163234, however, it becomes difficult to ensure the required sealing performance because of the complicated seat surface configuration, resulting in an increase in the production cost. In addition, it becomes structurally difficult to apply an initial deflection to the disk valve by a difference in projection height between a seat portion and a clamp portion for the disk valve. Consequently, the damping force characteristics are likely to vary undesirably.

### SUMMARY OF THE INVENTION

The present invention has been made in view of the above-described circumstances. Accordingly, an object of the present invention is to provide a shock absorber capable of preventing a sharp change in damping force to obtain smooth damping force characteristics.

The present invention provides a shock absorber including a cylinder having a fluid sealed therein, a piston slidably fitted in the cylinder, a fluid passage in which a flow of fluid is induced by sliding movement of the piston in the cylinder, and a damping force generating mechanism that generates a damping force by controlling the flow of fluid in the fluid passage. The damping force generating mechanism includes an orifice passage, an annular valve seat, a disk-shaped seat disk, a through-hole, and a disk valve. The orifice passage constantly allows the fluid to flow through the fluid passage. The valve seat is provided on a valve member through which the fluid passage extends. The seat disk is seated on the valve seat to form a valve chamber together with the valve seat. The seat disk opens upon receiving a pressure of fluid in the valve chamber. The through-hole is provided in the seat disk to communicate with the valve chamber. The disk valve is provided on the seat disk to open and close the through-hole. The disk valve has a pressure-receiving surface defined by a portion thereof that corresponds to the through-hole. The disk valve opens upon receiving a pressure of fluid in the valve chamber at the pressure-receiving surface. The disk valve has a valve-opening pressure lower than that of the seat disk. The through-hole is a slot extending in the circumferential direction of the seat disk or comprises a set of small holes arranged close to each other in the circumferential direction of the seat disk. When it opens, the disk valve partially opens the through-hole relative to the circumferential direction, thereby gradually increasing the flow path area of the through-hole.

### BRIEF DESCRIPTION OF THE DRAWINGS

FIG. 1 is an enlarged vertical sectional view showing a piston part that is a main part of a hydraulic shock absorber according to an embodiment of the present invention.

FIG. 2 is a plan view of a seat disk of the hydraulic shock absorber shown in FIG. 1.

FIG. 3 is a vertical sectional view of the hydraulic shock absorber shown in FIG. 1.

FIGS. 4A to 4C are perspective views of the piston part showing the way in which the seat disk and disk valve assembly of the hydraulic shock absorber shown in FIG. 1 are opened and closed.

FIG. 5 is an enlarged vertical sectional view showing a piston part of a modification of the shock absorber shown in FIG. 1.

FIG. 6 is a plan view of a disk valve assembly of the modification shown in FIG. 5.

FIG. 7 is a plan view of a modification of the seat disk of the hydraulic shock absorber shown in FIG. 1.

FIG. 8 is a graph showing extension damping force characteristics of the hydraulic shock absorber shown in FIG. 1.

FIGS. 9A to 9F are plan views of modifications of the seat disk of the hydraulic shock absorber shown in FIG. 1.

FIG. 10 is a chart showing the relationship between a slot arrangement in which four equally spaced slots are provided in the seat disk and the operating conditions of the seat disk and disk valve assembly in the hydraulic shock absorber shown in FIG. 1.

FIG. 11 is a chart showing the relationship between a slot arrangement in which five equally spaced slots are provided in the seat disk and the operating conditions of the seat disk and disk valve assembly in the hydraulic shock absorber shown in FIG. 1.

FIG. 12 is a chart showing the relationship between a slot arrangement in which six equally spaced slots are provided in the seat disk and the operating conditions of the seat disk and disk valve assembly in the hydraulic shock absorber shown in FIG. 1.

### DETAILED DESCRIPTION OF THE INVENTION

An embodiment of the present invention will be described below in detail with reference to the accompanying drawings.

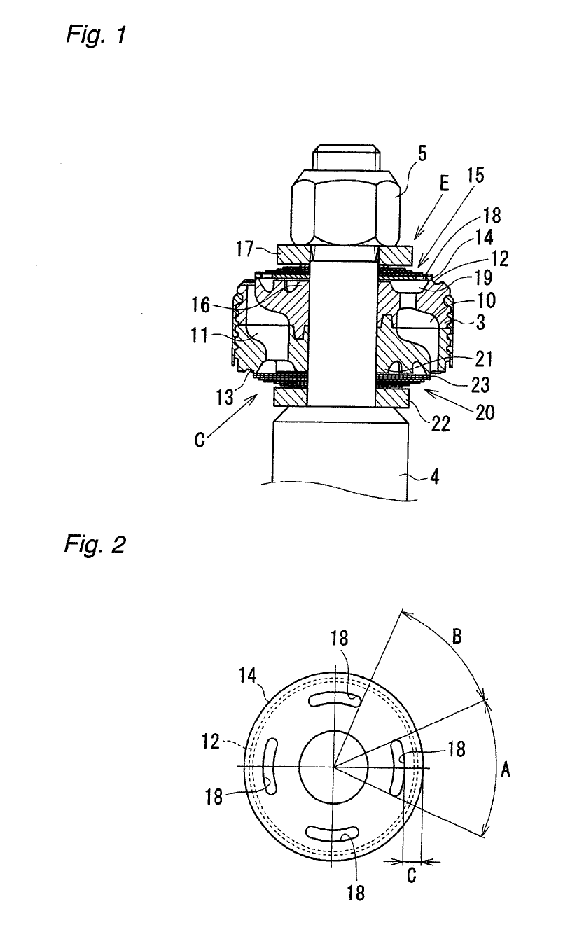

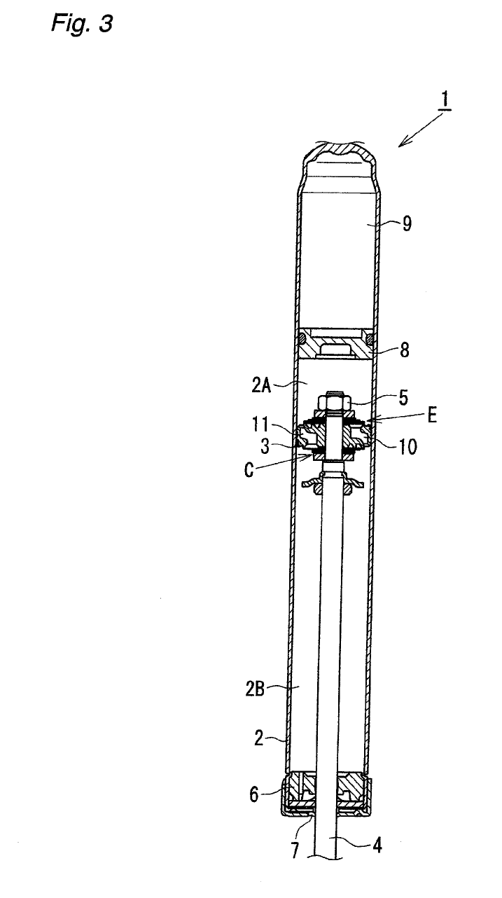

FIG. 3 is a general view showing the overall structure of a shock absorber according to this embodiment. A piston part as a main part of the shock absorber is shown in FIG. 1 in enlarged view. As shown in FIG. 3, the shock absorber 1 according to this embodiment is a single-cylinder type hydraulic shock absorber attached to a suspension system of an automobile. In the shock absorber 1, a piston 3 (valve member) is slidably fitted in a cylinder 2 having a hydraulic fluid (fluid) sealed therein. The piston 3 divides the inside of the cylinder 2 into two chambers, i.e. a cylinder upper chamber 2A and a cylinder lower chamber 2B. One end portion of a piston rod 4 extends through the piston 3 and is connected thereto with a nut 5. The other end portion of the piston rod 4 extends to the outside of the cylinder 2 through a rod guide 6 and an oil seal 7 that are fitted to the lower end of the cylinder 2. A free piston 8 is slidably fitted in the bottom portion of the cylinder 2 to form a gas chamber 9 to compensate for a volumetric change in the cylinder 2 due to extension and contraction of the piston rod 4 by the compression and expansion of a high-pressure gas sealed in the gas chamber 9.

As shown in FIG. 1, the piston 3 has a split structure comprising two axially split parts. The piston 3 is provided with an extension hydraulic fluid passage 10 (fluid passage) and a compression hydraulic fluid passage 11 that communicate between the cylinder upper and lower chambers 2A and 2B. The lower end of the extension hydraulic fluid passage 10 opens on an outer peripheral portion of the lower end surface of the piston 3. The upper end of the extension hydraulic fluid passage 10 opens on a portion of the upper end surface of the piston 3 closer to the center thereof. The upper end of the compression hydraulic fluid passage 11 opens on an outer peripheral portion of the upper end surface of the piston 3. The lower end of the compression hydraulic fluid passage 11 opens on a portion of the lower end surface of the piston 3 closer to the center thereof. The extension and compression hydraulic fluid passages 10 and 11 are provided with extension and compression damping force generating mechanisms E and C, respectively, which generate a damping force by controlling the flow of hydraulic fluid in the extension and compression hydraulic fluid passages 10 and 11 induced by sliding movement of the piston 3 in the cylinder 2.

The extension damping force generating mechanism E (damping force generating mechanism) will be explained below. The upper end surface of the piston 3 has an annular (substantially circular) valve seat 12 projecting at the inner peripheral side of the compression hydraulic fluid passage 11 so as to surround the opening of the extension hydraulic fluid passage 10. The lower end surface of the piston 3 has an annular (substantially circular) valve seat 13 projecting at the inner peripheral side of the extension hydraulic fluid passage 10 so as to surround the opening of the compression hydraulic fluid passage 11.

A disk-shaped seat disk 14 is seated on the valve seat 12 at the upper end surface of the piston 3. A plurality of disk valves constituting a disk valve assembly 15 are stacked on the seat disk 14 in the order of decreasing diameter. The diameter of the lowermost disk valve of the disk valve assembly 15 is smaller than that of the seat disk 14. The seat disk 14 and the disk valve assembly 15 are clamped and thus secured between an annular clamp portion 16 projecting at the center of the upper end surface of the piston 3 and an annular retainer 17 laid over the disk valve assembly 15 by tightening of the nut 5 screwed on the distal end portion of the piston rod 4. The projection height of the valve seat 12 is greater than that of the clamp portion 16, whereby an initial deflection is applied to the seat disk 14 and the disk valve assembly 15.

The seat disk 14 has, as shown in FIG. 2, four arcuate slots 18 (through-hole) provided in an outer peripheral portion thereof at equal spaces in the circumferential direction. The slots 18 are in communication with an annular valve chamber 19 formed at the inner side of the valve seat 12 by the seat disk 14 and are closed by the disk valve assembly 15 stacked on the seat disk 14. The disk valve assembly 15 receives the pressure in the valve chamber 19 at pressure-receiving surfaces defined by portions thereof that correspond to the slots 18. The disk valve assembly 15 is deflected to lift from the seat disk 14 by the pressure in the valve chamber 19. Thus, the disk valve assembly 15 partially opens the slots 18 relative to the circumferential direction according to the amount of deflection and gradually increases the flow path area of the slots 18. The seat disk 14 is higher in flexural rigidity than the disk valve assembly 15. Therefore, the seat disk 14 is deflected to lift from the valve seat 12 when the pressure in the valve chamber 19 further increases, after the disk valve assembly 15 has opened, and reaches the valve-opening pressure of the seat disk 14, thereby allowing the valve chamber 19 to communicate directly with the cylinder upper chamber 2A.

Next, the compression damping force generating mechanism C will be explained. A disk valve assembly 20 comprising a stack of disk valves is seated on the valve seat 13 at the lower end surface of the piston 3. The disk valve assembly 20 is clamped and thus secured between an annular clamp portion 21 projecting at the center of the lower end surface of the piston 3 and an annular retainer 22 laid over the disk valve assembly 20 by tightening of the nut 5. The projection height of the valve seat 13 is greater than that of the clamp portion 21, whereby an initial deflection is applied to the disk valve assembly 20. The disk valve assembly 20 is deflected to lift from the valve seat 13 and thus opens when the pressure in the cylinder upper chamber 2A reaches the valve-opening pressure thereof. The disk valve assembly 20 is provided with an orifice passage 23 (cut portion) that constantly communicates between the cylinder upper and lower chambers 2A and 2B through the compression hydraulic fluid passage 11.

The following is an explanation of the operation of this embodiment arranged as stated above.

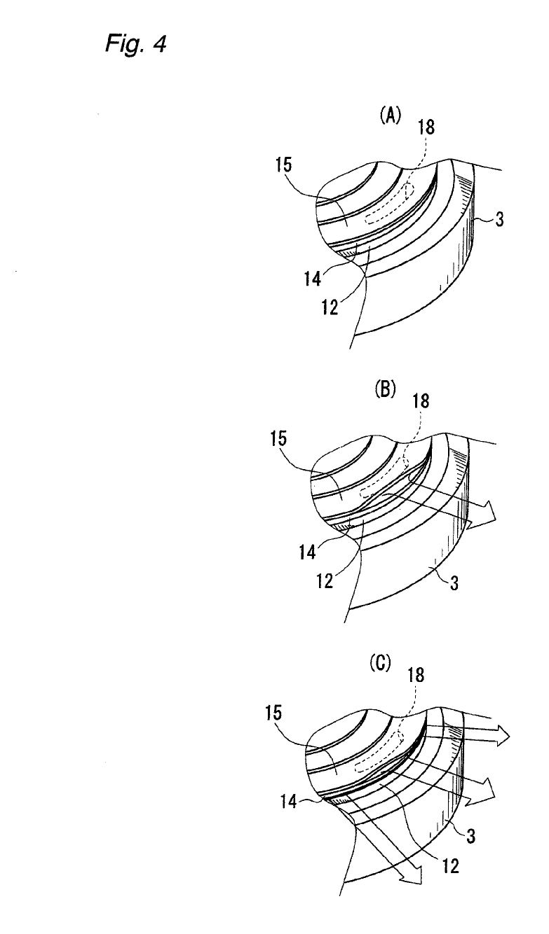

The operation during the extension stroke of the piston rod 4 will be explained below. In the low piston speed region, the sliding movement of the piston 3 in the cylinder 2 causes the hydraulic fluid in the cylinder lower chamber 2B to flow toward the cylinder upper chamber 2A through the orifice passage 23 of the disk valve assembly 20 and the compression hydraulic fluid passage 11, thus generating a damping force of orifice characteristics. In this regard, if the pressure at which the disk valve assembly 15 opens is set low, the system can be set so that substantially no orifice damping force characteristics will be exhibited, as described later. At this time, the pressure in the valve chamber 19 has not yet reached the valve-opening pressure of the disk valve assembly 15. Therefore, the disk valve assembly 15 does not open as shown in FIG. 4A.

When the piston speed increases and shifts to the intermediate piston speed region, the pressure in the valve chamber 19 reaches the valve-opening pressure of the disk valve assembly 15. Consequently, the disk valve assembly 15 opens to allow the hydraulic fluid in the cylinder lower chamber 2B to flow toward the cylinder upper chamber 2A through the extension hydraulic fluid passage 10, the valve chamber 19 and the slots 18 of the seat disk 14. Thus, the disk valve assembly 15 generates a damping force of valve characteristics. At this time, the disk valve assembly 15 partially deflects to partially open the slots 18 relative to the circumferential direction, as shown in FIG. 4B, thereby gradually increasing the flow path area. As the piston speed increases, the disk valve assembly 15 wholly deflects to wholly open the slots 18, as shown in FIG. 4C, thereby further increasing the flow path area. This allows the damping force characteristics to smoothly shift from the low to intermediate piston speed region without a sharp change in damping force. Further, linear damping force characteristics can be obtained even in the low piston speed region by setting the system so that the piston speed at which the disk valve assembly 15 partially deflects and begins to partially open the slots 18 relative to the circumferential direction is sufficiently low. It should be noted that there may be conventional hydraulic shock absorbers in which the disk valve assembly is regarded as partially open from a microscopic viewpoint. It is, however, desirable that damping force characteristics should be set to shift from the low to intermediate piston speed region smoothly while allowing the driver to feel a smooth change in damping force during the shift from the low to intermediate piston speed region. In other words, it is desirable that the transitional region from the low to intermediate piston speed region should have a certain range. The range differs from driver to driver; empirically, the range is not less than 0.1 m/sec in terms of the piston speed.

When the piston speed further increases to shift to the high piston speed region, the pressure in the valve chamber 19 reaches the valve-opening pressure of the seat disk 14. Consequently, the seat disk 14 deflects to lift from the valve seat 12 to enlarge the flow path area, thereby preventing an excessive increase in damping force.

FIG. 8 shows damping force characteristics during the extension stroke of the piston rod 4. As shown in FIG. 8, in contrast to the damping force characteristics obtained by the orifice and the disk valve assembly in the conventional shock absorber (see the broken line in FIG. 8), the damping force characteristics smoothly shift from the low to high piston speed region, and linear damping force characteristics can be obtained in the low piston speed region (substantially no orifice damping force characteristics are observed because the valve-opening pressure of the disk valve assembly 15 is low). In addition, an excessive increase in damping force is suppressed in the high piston speed region. It is also possible to increase the damping force in the high piston speed region by reducing the flow path area of the extension hydraulic fluid passage 10 in the piston 3 relative to the flow path area of the slots 18 so that the flow path is narrowed by the extension hydraulic fluid passage 10 after the disk valve assembly 15 has opened.

A circular valve seat 12 can be formed on the piston 3. That is, there is no need for a valve seat having a complicated configuration as disclosed in the above-described Japanese Patent Application Publication No. Hei 3-163234. In addition, the seat disk 14 having the slots 18 can be readily produced by press forming. Therefore, the production cost can be reduced. The use of the circular valve seat 12 allows an initial deflection to be readily applied to the seat disk 14 and the disk valve assembly 15 by a difference in projection height between the valve seat 12 and the clamp portion 16, and thus the variation of damping force characteristics can be reduced.

During the compression stroke of the piston rod 4, the sliding movement of the piston 3 in the cylinder 2 causes the hydraulic fluid in the cylinder upper chamber 2A to flow toward the cylinder lower chamber 2B through the compression hydraulic fluid passage 11. In the low piston speed region, the orifice passage 23 generates a damping force of orifice characteristics. In the intermediate and high piston speed regions, the disk valve assembly 20 opens to generate a damping force of valve characteristics.

The following is an explanation of the arrangement and configuration of the slots 18 in the seat disk 14 suitable for the shock absorber 1 to offer the expected operational advantage. The explanation will be made with reference to FIGS. 2 and 10 to 12.

In order for the shock absorber 1 to offer the expected operational advantage, it is necessary that the disk valve assembly 15 should open before the seat disk 14 does in response to an increase in the piston speed. In addition, it is necessary for the disk valve assembly 15 to begin to partially deflect relative to the circumferential direction upon receiving the pressure at the portions thereof corresponding to the slots 18, thereby gradually enlarging the flow path area of the slots 18. In other words, the disk valve assembly 15 needs to be prevented from deflecting substantially at once over the entire circumference thereof in order to prevent the slots 18 from fully opening at once.

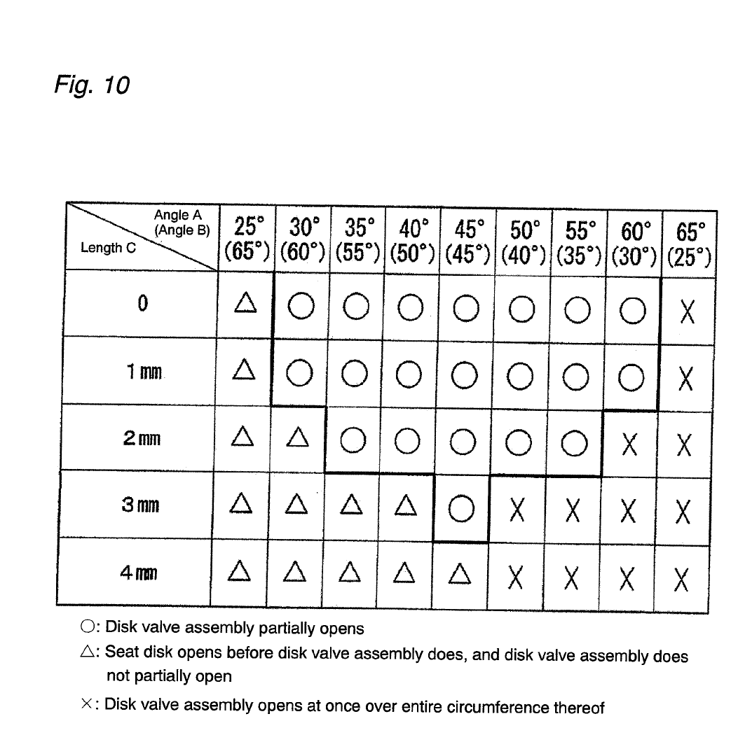

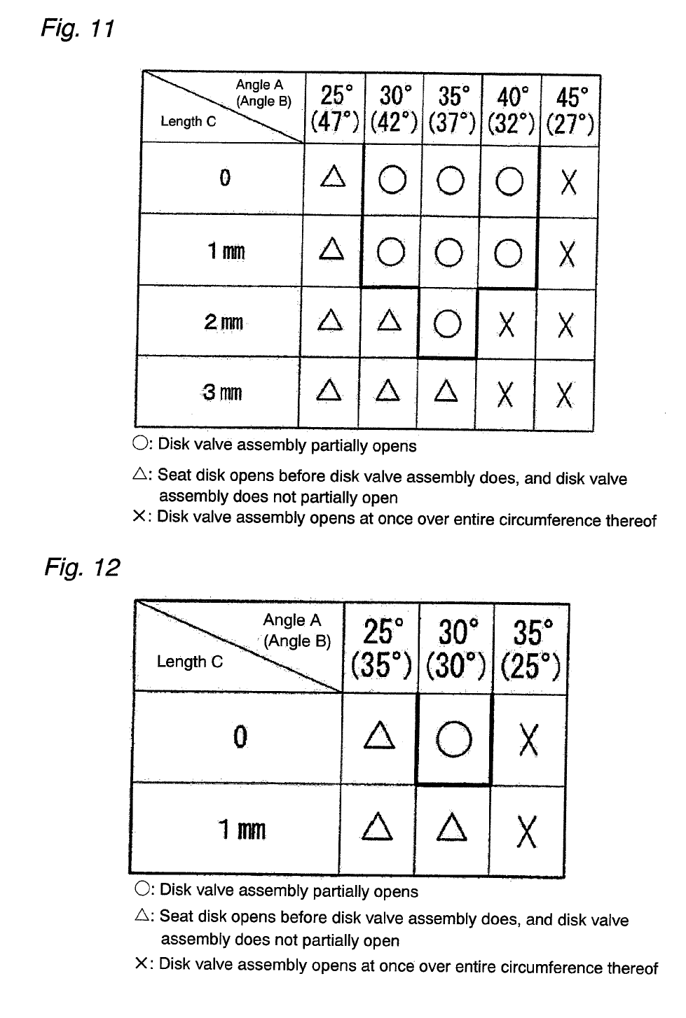

In FIG. 2, reference symbol A represents the central angle of a range over which each slot 18 extends in the circumferential direction. Reference symbol B represents the central angle of a circumferential area between each pair of mutually adjacent ones of the four slots 18. Reference symbol C represents the radial distance between each slot 18 and the valve seat 12. FIG. 10 shows the operating conditions of the seat disk 14 and the disk valve assembly 15 in a case where the central angles A and B and the radial distance C are varied. FIG. 11 shows the operating conditions of the seat disk 14 and the disk valve assembly 15 in a case where five equally spaced slots 18 are provided in the seat disk 14. FIG. 12 shows the operating conditions of the seat disk 14 and the disk valve assembly 15 in a case where six equally spaced slots 18 are provided in the seat disk 14. It should be noted that the diameter of the piston 3 is 32 mm; the diameter of the piston rod 4 is 12.5 mm, the diameter of the annular valve seat 12 is 25 mm; and the width of each slot 18 is 1.5 mm.

In FIGS. 10 to 12, the mark ◯ represents a condition in which the disk valve assembly 15 can partially open the slots 18 relative to the circumferential direction; the mark Δ represents a condition in which the seat disk 14 undesirably opens before the disk valve assembly 15 does; and the mark X represents a condition in which the disk valve assembly 15 undesirably opens at once over the entire circumference thereof.

In view of these results, it is desirable for the shock absorber 1 to satisfy the following conditions in order to offer the expected operational advantage: (1) the central angle A of the range over which each slot 18 extends in the circumferential direction should be not less than 30 degrees, preferably not less than 35 degrees, and the central angle B of the circumferential area between each pair of mutually adjacent slots 18 should be not less than 30 degrees; and (2) the slots 18 should be provided close to the valve seat 12, i.e. the radial distance C between each slot 18 and the valve seat 12 should be not more than 3 mm.

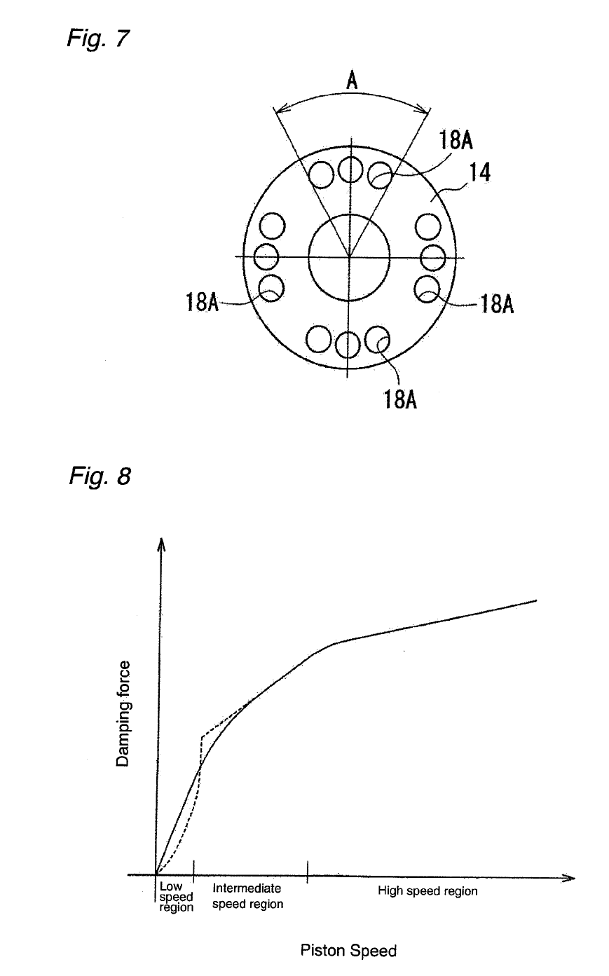

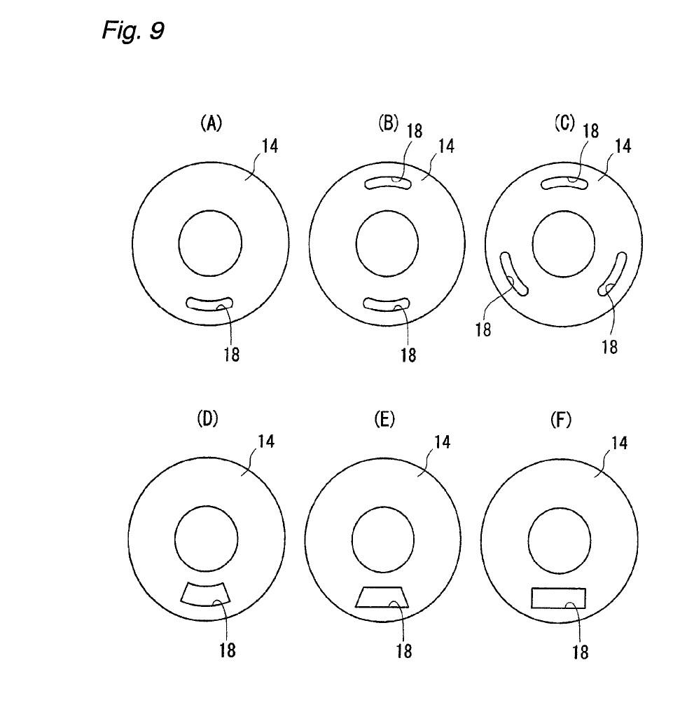

Regarding the arrangement of the slots 18 in the seat disk 14, the number of slots 18 need not be four, five or six as in the above-described arrangements but may be any one of one, two and three as shown in FIGS. 9A, 9B and 9C, for example. The number of slots 18, however, is preferably not less than two from the viewpoint of durability. The upper limit of the number of slots 18 is about ten from the viewpoint of allowing the slots 18 to be partially opened. Regarding the positioning of a plurality of slots 18, they need not be equally spaced from each other but may be unevenly distributed in the circumferential direction of the seat disk 14. The slots 18 need not be in symmetry with respect to the center of the seat disk 14. Each slot 18 need not be arcuate in shape but may have any configuration, provided that it extends in the circumferential direction. For example, the slots 18 may have any one of sectorial, trapezoidal and rectangular configurations as shown in FIGS. 9D, 9E and 9F. The slots 18 need not have the same configuration. Each slot 18 may be replaced, as shown in FIG. 7, with a set of a plurality of circular small holes 18A arranged close to each other in the circumferential direction. With this arrangement, the seat disk 14 can be improved in rigidity and durability in comparison to a structure in which each slot 18 has substantially the same central angle as that of the set of small holes 18A. The radial positions of the small holes 18A need not be the same.

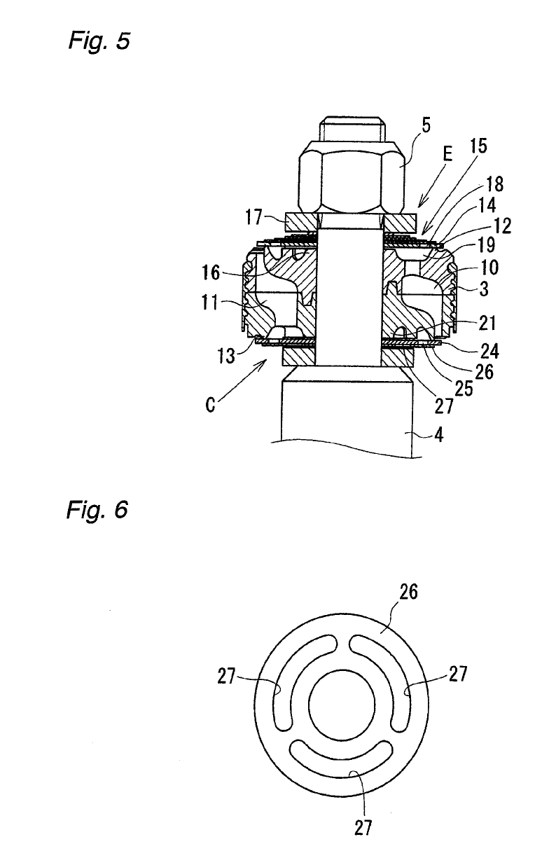

Next, a modification of the above-described embodiment will be explained with reference to FIGS. 5 and 6. In the following modification, members or portions similar to those in the above-described embodiment are denoted by the same reference numerals as used in the foregoing embodiment, and only portions in which the modification differs from the embodiment will be explained in detail.

In the modification shown in FIG. 5, a seat disk 24 and a disk valve assembly 26 that opens and closes slots 25 of the seat disk 24 are provided in place of the disk valve assembly 20 as the compression damping force generating mechanism C in the same way as the extension damping force generating mechanism E. In place of the orifice passage 23 provided in the disk valve assembly 20, an orifice passage (cut portion; not shown) is provided in the seat disk 24 to constantly communicate between the cylinder upper and lower chambers 2A and 2B through the compression hydraulic fluid passage 11. In order to set the compression damping force smaller than the extension damping force, the number of disk valves stacked to constitute the disk valve assembly 26 is reduced in comparison to the disk valve assembly 15. In addition, as shown in FIGS. 5 and 6, the disk valve assembly 26 is provided with arcuate cut portions 27 at respective positions corresponding to the inner peripheral sides of the slots 25 of the seat disk 24, thereby reducing the flexural rigidity of the disk valve assembly 26.

With the above-described structure, damping force characteristics similar to those for the extension stroke in the above-described embodiment can also be obtained during the compression stroke of the piston rod 4. During the extension stroke, the seat disk 24 supports the disk valve assembly 26 that receives the pressure in the cylinder lower chamber 2B. Therefore, the durability of the disk valve assembly 26 can be improved.

In the foregoing embodiment and the modification thereof, the present invention is applied to damping force generating mechanisms provided in the piston part, by way of example. The present invention, however, is not necessarily limited thereto but may be applied to other damping force generating mechanisms. For example, the present invention may be used in a hydraulic shock absorber including a reservoir having a hydraulic oil and a gas sealed therein. More specifically, the present invention may be applied to a damping force generating mechanism provided in a base valve (valve member) that divides the inside of the cylinder and the reservoir from each other. The present invention may also be applied to damping force generating mechanisms provided in various hydraulic fluid passages. Further, in the foregoing embodiment and the modification thereof, the present invention is applied to a hydraulic shock absorber that generates a damping force by controlling the flow of hydraulic oil. The present invention, however, is not necessarily limited thereto but may be similarly applied to a shock absorber that generates a damping force by controlling the flow of other fluid, e.g. a gas.

With the shock absorber according to the above-described embodiment, when a disk valve opens, it partially opens a through-hole (a slot 18 provided in a seat disk to extend in the circumferential direction thereof, or a set of small holes 18A arranged close to each other in the circumferential direction of the seat disk) relative to the circumferential direction, thereby gradually increasing the flow path area. Therefore, it is possible to prevent a sharp change in damping force to obtain smooth damping force characteristics.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention. Moreover, all features of all embodiments and all claims can be combined with each other, as long as they do not contradict each other.

The present application claims priority under 35 U.S.C. section 119 to Japanese Patent Application No. 2008-50619, filed on Feb. 29, 2008. The entire disclosure of Japanese Patent Application No. 2008-50619 including specification, claims, drawings and summary is incorporated herein by reference in its entirety.

What is claimed is:

1. A shock absorber comprising:
a cylinder having a fluid sealed therein;
a piston slidably fitted in said cylinder;
a fluid passage in which a flow of fluid is induced by sliding movement of the piston in said cylinder; and
a damping force generating mechanism that generates a damping force by controlling the flow of fluid in said fluid passage;
said damping force generating mechanism including:
an orifice passage that constantly allows the fluid to flow through said fluid passage;
an annular valve seat provided on a valve member through which said fluid passage extends;
a disk-shaped seat disk seated on said valve seat to form a valve chamber together with said valve seat, said seat disk being adapted to open upon receiving a pressure of fluid in said valve chamber;
a through-hole provided in said seat disk to communicate with said valve chamber; and
a disk valve provided on said seat disk to open and close said through-hole, said disk valve having a pressure-receiving surface defined by a portion thereof that corresponds to said through-hole, said disk valve being adapted to open upon receiving a pressure of fluid in said valve chamber at the pressure-receiving surface;
said disk valve having a valve-opening pressure lower than a valve-opening pressure of said seat disk;
said through-hole being either one of a slot extending in a circumferential direction of said seat disk and a set of small holes arranged close to each other in the circumferential direction of said seat disk;
wherein, when it opens, said disk valve partially opens said through-hole relative to the circumferential direction, thereby gradually increasing a flow path area of said through-hole.

2. The shock absorber of claim 1, wherein,
in a low piston speed region, a damping force is mainly generated by said orifice passage, and,
in an intermediate piston speed region, a damping force is mainly generated according to a degree of opening of said disk valve, and further,
in a high piston speed region, a damping force is generated according to a degree of opening of said seat disk, and wherein,
in a transitional region from said low piston speed region to said intermediate piston speed region, said disk valve partially opens relative to a circumferential direction thereof, thereby gradually changing the damping force.

3. The shock absorber of claim 2, wherein said transitional region has a range not less than 0.1 m/sec in terms of a piston speed.

4. The shock absorber of claim 1, wherein, when said disk valve opens, said disk valve partially opens said through-hole relative to the circumferential direction in a piston speed region having a predetermined range, thereby gradually increasing the flow path area of said through-hole.

5. The shock absorber of claim 1, wherein said slot has any one of sectorial, trapezoidal and rectangular configurations.

6. The shock absorber of claim 1, wherein said through-hole has a flow path area larger than that of said fluid passage.

7. The shock absorber of claim 1, wherein there are provided a plurality of said through-holes.

8. The shock absorber of claim 7, wherein said through-holes are arranged in symmetry with respect to a center of said seat disk.

9. The shock absorber of claim 1, wherein said through-hole extends over a range having a central angle of not less than 35 degrees.

10. The shock absorber of claim 1, wherein said disk valve has a cut portion at a position corresponding to an inner peripheral side of said through-hole.

11. A shock absorber comprising:
a cylinder having a fluid sealed therein;
a piston slidably fitted in said cylinder;
a fluid passage in which a flow of fluid is induced by sliding movement of the piston in said cylinder; and
a damping force generating mechanism that generates a damping force by controlling the flow of fluid in said fluid passage;
said damping force generating mechanism including:
a disk-shaped seat disk that opens upon receiving a pressure of fluid in said fluid passage;
a through-hole provided in said seat disk; and
a disk valve assembly comprising a plurality of disk valves provided on said seat disk to open and close said through-hole, said disk valve assembly having a pressure-receiving surface defined by a portion thereof that corresponds to said through-hole, said disk valve assembly being adapted to open upon receiving a pressure of fluid in said fluid passage at the pressure-receiving surface;
said disk valve assembly having a valve-opening pressure lower than a valve-opening pressure of said seat disk;
said through-hole having a length in a circumferential direction of said seat disk that is longer than a length thereof in a radial direction of said seat disk;
wherein, when it opens, said disk valve assembly partially opens said through-hole relative to the circumferential direction, thereby gradually increasing a flow path area of said through-hole.

12. A shock absorber comprising:
a cylinder having a fluid sealed therein;
a piston slidably fitted in said cylinder;
a fluid passage in which a flow of fluid is induced by sliding movement of the piston in said cylinder; and
a damping force generating mechanism that generates a damping force by controlling the flow of fluid in said fluid passage;
said damping force generating mechanism including:
a valve seat provided on a valve member through which said fluid passage extends;
a seat disk seated on said valve seat, said seat disk being adapted to open upon receiving a pressure of fluid in said fluid passage;
a plurality of through-holes provided in said seat disk to communicate with said fluid passage; and
a disk valve assembly comprising a plurality of disk valves provided on said seat disk to open and close said through-holes, said disk valve assembly having pressure-receiving surfaces defined by portions thereof that correspond to said through-holes, said disk valve assembly being adapted to open upon receiving a pressure of fluid in said fluid passage at the pressure-receiving surfaces;
said through-holes being arranged at a predetermined spacing, facing a peripheral edge portion of said disk valve assembly so that said disk valve assembly partially opens.
